(19) United States
(12) Patent Application Publication
(10) Pub. No.: US 2008/0156786 A1
(43) Pub. Date: Jul. 3, 2008

(54) Direct current powered heating pad for bed

(76) Inventor: Seung Mo Choi, Seoul (KR)

Correspondence Address: GWIPS;Peter T. Kwon, Gwacheon P.O. Box 72, 119 Byeolyang Ro, Gwacheon City, Gyeonggi-Do, 427-600, omitted

(21) Appl. No.: 11/783,754

(22) Filed: Apr. 10, 2007

(30) Foreign Application Priority Data
Dec. 29, 2006 (KR) 10-2006-0137610

(51) Int. Cl. H05B 3/14

(52) U.S. Cl. 219/212; 219/481; 219/482

(57) ABSTRACT

A DC powered electric heating pad for a bed is invented comprising a plurality of carbon fiber filaments (2a) arranged in parallel for generating heat, a power distributing element (2c) for supplying power to the carbon fiber filaments (2a), a pair of metal bands (2b) for coupling both ends of the carbon fiber filaments (2a) and distributing the power supplied through the power distributing element (2c), a thermal material (2) for enveloping the carbon fiber filaments (2a) to consistently maintain the heat, and covering materials (1, 3) for protecting the thermal material (2) and the carbon fiber filaments (2a). An adapter with a bridge rectifier circuit is plugged into a regular outlet of AC as a power source for transforming to DC. The carbon fiber filament (2a) emitting the far-infrared with negative ions is designed to have excellent conductivity, durability, and ultra-light weight for protecting against harmful electrical waves by using DC.

### BACKGROUND OF THE INVENTION

1. Field of the Invention

The present invention relates to an electric heating pad for a bed. More particularly, the Direct Current (DC) powered heating pad comprises a plurality of carbon fiber filaments for generating heat that are designed to emit the far infrared and negative ions, and an adapter for transforming to DC that plugs into a regular outlet of AC as a power source. The carbon fiber filament (2a) has the properties of excellent conductivity, durability and ultra-light weight and is designed to protect the user from harmful electrical waves.

2. Description of the Related Art

Generally, an electric heating pad for a bed is used to provide a warm and comfortable environment for cozy sleeping.

The conventional electric heating pad using thin Nichrome wires or fiber glasses for generating heat has a problem that the heat generating elements are easily broken or disconnected due to poor durability.

The conventional electric heating pad also has a problem of forming a magnetic field or emitting harmful electrical waves due to the alternating current used as a power source.

Further, some conventional electric heating pads may develop open circuit problems due to the poor conductivity or poor durability, and they are heavy in weight.

Thus, it is necessary to develop a reliable, ultra-light weight, DC powered heating pad for a bed, which has better efficiency, conductivity, and durability than the conventional art.

### SUMMARY OF THE INVENTION

In order to solve the aforementioned problems, the D.C. powered electric heating pad for a bed of the present invention is provided.

An objective of the present invention is to provide a D.C. powered heating pad comprising a plurality of carbon fiber filaments for emitting the far-infrared with negative ions, which have an excellent conductivity, durability and ultra-light weight. Thus, it is possible to protect the user from the harmful electrical waves. An adapter with circuitry is plugged into a regular outlet of AC as a power source for transforming to D.C.

Another objective of the present invention is to provide a DC powered heating pad for a bed comprising a plurality of carbon fiber filaments (2a) arranged in parallel for generating heat, a power distributing element (2c) for supplying power to the plurality of carbon fiber filaments (2a), a pair of metal bands (2b) for coupling both ends of the carbon fiber filaments (2a) and distributing the power supplied through the power distributing element (2c), a thermal material (2) for enveloping the plurality of carbon fiber filaments (2a) to consistently maintain the heat, and a set of covering materials (1, 3) for protecting the thermal material (2) and the carbon fiber filaments (2a).

### BRIEF DESCRIPTION OF THE DRAWINGS

FIG. 1 is a sectional view of a DC powered electric heating pad for a bed of the present invention.

FIG. 2 is a plan view of a DC powered electric heating pad for a bed of the present invention.

FIG. 3 is a schematic drawing of a carbon fiber material of the present invention.

FIG. 4 is an enlarged drawing of an electric distribution devise of the present invention.

FIG. 5 shows the adapter circuitries of the present invention and their electrical wave forms.

### DESCRIPTION OF THE PREFERRED EMBODIMENTS

For achieving the above objectives, a Direct Current (DC) powered heating pad for a bed is invented comprising a plurality of carbon fiber filaments (2a) arranged in parallel for generating heat, a power distributing element (2c) for supplying power to the plurality of carbon fiber filaments (2a), a pair of metal bands (2b) for coupling both ends of the carbon fiber filaments (2a) and distributing the power supplied through the power distributing element (2c), a thermal material (2) for enveloping the plurality of carbon fiber filaments (2a) to consistently maintain the heat, and a set of covering materials (1, 3) for protecting the thermal material (2) and the carbon fiber filaments (2a).

Further, the carbon fiber filaments (2a) in the DC powered heating pad are composed of more than 3,000 threads stranded together. The metal bands (2b) of the DC powered heating pad are made of copper.

An adapter with circuitry is designed to plug into a regular outlet of Alternating Current (AC) as a power source for transforming to Direct Current (DC). The adapter employs circuitry for preventing the emission of harmful electrical waves and for controlling the heating load.

Hereinafter, a D.C. powered heating pad for a bed of the present invention is described in detail with reference to the accompanying drawings.

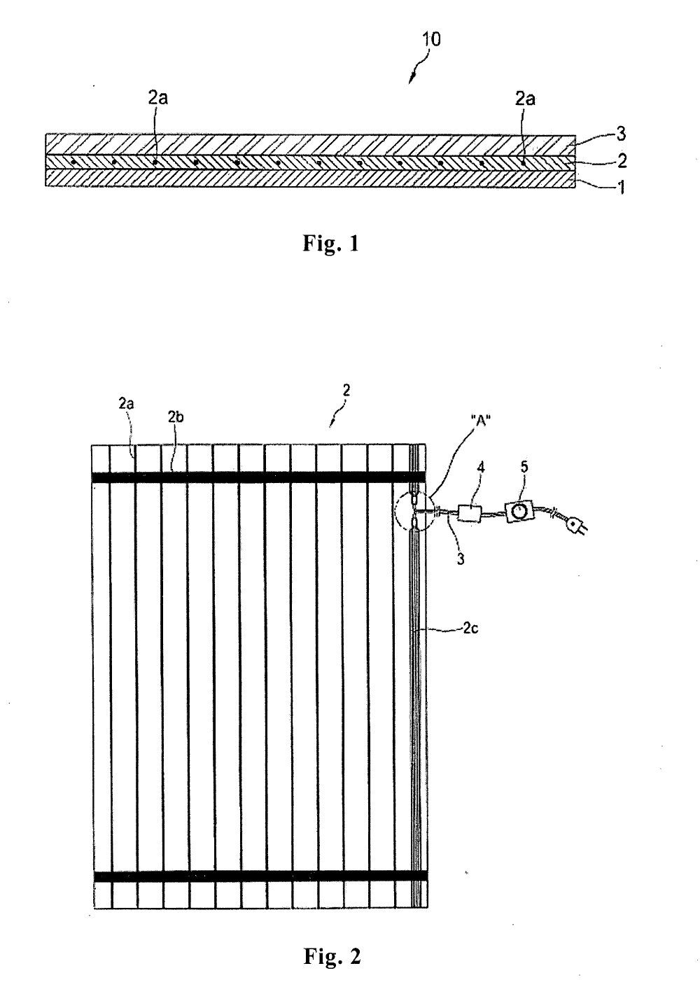

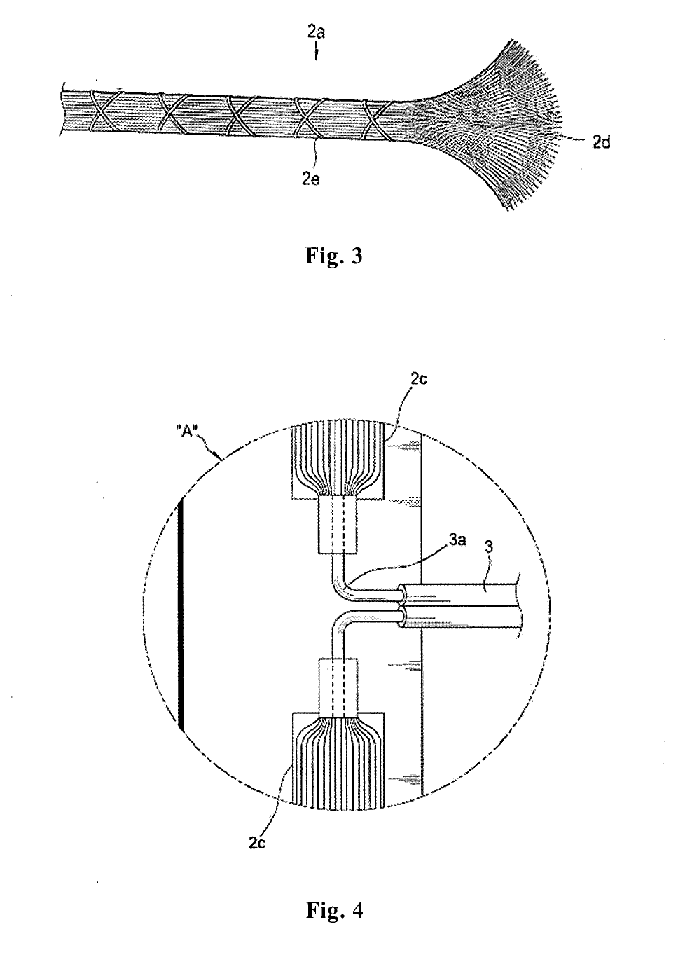

As seen in FIG. 1, a sectional view of a DC powered heating pad for a bed is presented. A plan view of a DC powered heating pad for a bed is shown in FIG. 2. A schematic drawing of a carbon fiber filament is shown in FIG. 3. As shown in FIG. 4, an enlarged drawing of an electric distribution devise in the heating material is presented The D.C. powered heating pad (10) for a bed of the present invention comprises the carbon fiber filament (2a) as a heat generating element, a pair of metal bands (2b) forming a flexible strap and a power distributing element (2c).

As shown in FIG. 1, a thermal material (2) envelops the carbon fiber filament (2a) for maintaining the consistent temperature, a bottom cover (1) for reinforcing the thermal material (2) and a top cover (3) for protecting the thermal material (2) and the carbon fiber filament (2a).

As shown in FIG. 2, the D.C. powered heating pad (10) for a bed of the present invention shows that a plurality of the carbon fiber filaments (2a) is arranged in parallel to the long edge of the heating pad for easily rolling up along with its width and bonded at its proximal ends by a pair of metal bands (2b) for supplying the power. Alternatively, it is possible that the plurality of carbon fiber filaments (2a) is arranged in parallel to the short edge of the heating pad for easily rolling up along its length and bonded at its proximal ends by a pair of metal bands (2b) for supplying the power.

As shown in FIG. 3, the carbon fiber filament (2a) is made up of more than 3,000 strands (2d) to form a filament (2e).

As described, the carbon fiber filament (2a) of the present invention is produced for emitting the far-infrared with negative ions, which have an excellent conductivity, durability and ultra-light weight. Therefore, it is possible to increase the efficiency and to protect the user from the harmful electrical waves.

As shown in FIG. 2, the power distributing element (2c) in the D.C. powered heating pad (10) is connected to the pair of metal bands (2b) for supplying the power to the carbon fiber filament (2a).

As shown in FIG. 4, the power distributing element (2c) is connected to the terminal (3a) of the electric cord (3) for supplying the power to the power distributing element (2c) and the pair of metal bands (2b). A temperature controller (5) for setting the desired heat level is attached to the electric cord (3) near a plug.

As seen in FIG. 2, the pair of metal bands (2b) coupled to the proximal ends of the carbon fiber filament (2a) are connected to the power distributing element (2c) for supplying the power.

For the metal bands (2b), one end of the metal band connected to a terminal of the electric cord (3) acts as a positive pole “+” and the other end of the metal band connected to another terminal of the electric cord (3) acts as a negative pole “−” in the power distributing element (2c), so that the DC current flows through the carbon fiber filaments (2a) for generating heat. The metal bands (2b) made of copper are formed as flexible bands, for the best conductivity.

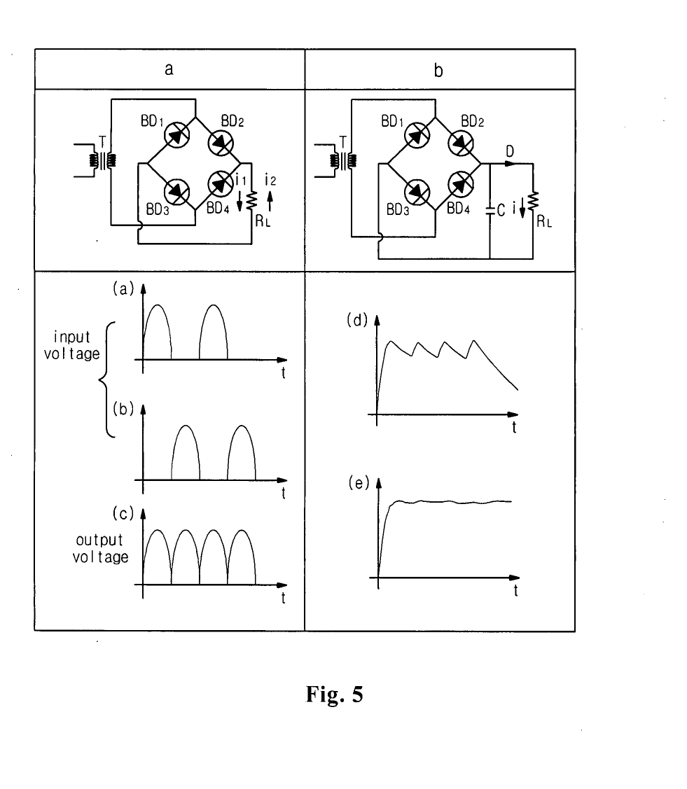

As shown in FIGS. 2 and 5 for protecting against the electric waves, an adapter (4) equipped with a rectifier circuit is employed for transforming the Alternating Current (AC) to the Direct Current (DC). The DC powered heating pad (10) of the present invention is directly plugged into a regular outlet as a power source. The adapter (4) employing a rectifier circuitry for preventing the emission of harmful electrical waves and a temperature controller (5) for controlling the heating load are installed on the electric cord (3).

Further, it is possible to use either one of a half wave, full wave or back-voltage rectifier circuitries for the adapter. But the adapter (4) of the present invention employs a bridge rectifier circuit

As shown in FIG. 5, the adapter with the bridge rectifier circuits of the present invention and their electrical wave forms are presented for illustrating the principle of the offset electrical waves in the bridge rectifier circuit of the adapter.

In case “a” of FIG. 5, a state is shown in which the voltage is dropped by the transformer (T) to be lager than zero (V>0) in the bridge rectifier circuit, in which state the current (i) does not flow through the BD1 and BD4 due to the reverse bias direction. Instead, the current (i1) will flow through the BD2 and BD3, which are in the bias direction. When the voltage is larger than zero (V>0), the current (i1) having a wave form as shown in “a” flows through the BD2, RL and BD3. When the voltage is smaller than zero (V<0), the current (i2) having a wave form as shown in “b” flows through the BD4, RL and BD1, but in the same direction as the previous “a” of the current (i1). As a result, the total current (i) will be (i1+i2) through the load resistance as shown by the “c” wave form to be offset from the waves through the bridge rectifier circuit.

In the case “b” of FIG. 5, it is shown that a condenser (C) and a diode (D) are added in the bridge rectifier circuit for extending the duration of the peak voltage. Due to the additional condenser (C) and diode (D) in the bridge rectifier circuit, the wave form will be output as shown in “d” of FIG. 5. Beside the condenser (C) and diode (D), an inductor and clamping can be added to the constant voltage circuit or the rectifier circuit to produce the output of the horizontal wave form as shown in “e” of FIG. 5 for effectively offsetting the electrical waves.

The D.C. powered heating pad (10) for a bed having a configuration as described above generates heat as follows:

When a user plugs the D.C. powered heating pad (10) into a regular wall outlet of Alternating Current (AC) as a power source, the adapter transforms the power to Direct Current (DC) for supplying the power to the carbon fiber filaments (2a) for generating heat through the electric cord (3), the power distributing element (2c) and the metal bands (2b).

At the same time, one end of the metal band connected to a terminal of the electric cord (3) acts as a positive pole “+” and the other end of the metal band connected to another terminal of the electric cord (3) acts as a negative pole “−”, so that the DC current flows through the carbon fiber filaments (2a) for generating heat.

As the adapter transforms the AC to DC through the bridge rectifier circuit, the harmful electrical waves are offset from each other to protect the user through the control of the heating load.

Accordingly, the D.C. powered heating pad is designed to emit the useful far-infrared with negative ions, which have an excellent conductivity, durability and ultra-light weight. Therefore, it is possible to protect the user from the harmful electrical waves by offsetting the electrical waves through the bridge rectifier circuit.

Although the D.C. powered heating pad for a bed of the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A Direct Current (DC) powered heating pad for a bed comprising:
a plurality of carbon fiber filaments (2a) arranged in parallel for generating heat,
a power distributing element (2c) for supplying power to the plurality of carbon fiber filaments (2a),
a pair of metal bands (2b) for coupling both ends of the carbon fiber filaments (2a) and distributing the power supplied through the power distributing element (2c),
a thermal material (2) for enveloping the plurality of carbon fiber filaments (2a) arranged in parallel to consistently maintain the heat, and
a set of covering materials (1, 3) for protecting said thermal material (2) and said carbon fiber filaments (2a).

2. The DC powered heating pad as claimed in claim 1, wherein said carbon fiber filaments (2a) are made up of more than 3,000 strands.

3. The DC powered heating pad as claimed in claim 1, wherein said metal bands (2b) are made of copper that forms a flexible strap.

4. The DC powered heating pad as claimed in claim 1, further comprising an adapter including circuitry, wherein said adapter is directly plugged into a regular wall outlet of Alternating Current (AC) as a power source, so that said adapter transforms the AC to Direct Current (DC).

5. The DC powered heating pad as claimed in claim 4, wherein said circuitry is a bridge rectifier circuit.

6. The DC powered heating pad as claimed in claim 5, wherein said bridge rectifier circuit further comprises a condenser (C) and a diode (D).

7. The DC powered heating pad as claimed in claim 1, wherein said plurality of carbon fiber filaments (2a) is arranged in parallel to the length of the heating pad for easily rolling up along the width.

8. The DC powered heating pad as claimed in claim 1, wherein said plurality of carbon fiber filaments (2a) is arranged in parallel to the width of the heating pad for easily rolling up along the length.
